(19) United States
(12) Patent Application Publication
(10) Pub. No.: US 2003/0203063 A1
(43) Pub. Date: Oct. 30, 2003

(54) Air release molding system

(76) Inventor: Kazuaki Ano, Hayami-gun (JP)

Correspondence Address: TEXAS INSTRUMENTS INCORPORATED, P O BOX 655474, M/S 3999, DALLAS, TX, 75265

(21) Appl. No.: 10/136,834

(22) Filed: Apr. 30, 2002

(51) Int. Cl. B29C 45/14; B29C 45/43

(52) U.S. Cl. 425/117; 425/556

(57) ABSTRACT

An air release molding system that injects high-pressure air into the die during the mold die release to eradicate mold resin sticking onto the mold die during the die release process.

### BACKGROUND OF THE INVENTION

1. Field of the Invention

This invention relates generally to mold die releasing, and more particularly to an air release molding system that injects high-pressure air into the die during the mold die release to eradicate mold resin sticking onto the mold die during the die release process.

2. Description of the Prior Art

Package body sizes associated with integrated circuit (IC) substrates and lead frames have rapidly been increasing. These size increases have made it increasingly popular and preferable to employ the block mold method in order to map different type substrates or lead frames. The die release method that is employed when using a block mold technique to manufacture transfer molded ICs is critical to elimination of mechanical stresses placed on the IC chips in order to prevent delamination between the molded resin and the substrate.

Known die release systems and methods require the use of ejector pins such as illustrated in FIGS. 1(a)-1(c), or a release film such as illustrated in FIGS. 2(a)-2(c), to separate transfer molded ICs from the die. Use of ejector pins is problematic since the ejector pins place additional mechanical stresses on the IC chips during the die release process. Use of release films to separate transfer molded ICs from the die is problematic since this technique requires additional mechanisms beyond those generally required with conventional transfer molding systems, thereby running up the system costs while reducing system reliability.

In view of the foregoing, it would both desirable and advantageous to provide a mold die release technique that does not require ejector pins or a release film to separate transfer molded integrated circuits from the die.

### SUMMARY OF THE INVENTION

The present invention is directed to an air release molding system that injects high-pressure air into the die chamber during the mold die release to eradicate mold resin sticking onto the mold die during the die release process. The air release molding system is an injection mold comprising a lower die configured for placement of a substrate having an IC chip attached there upon. The air release molding system further comprises an upper die having a mold injection chamber disposed therein. The upper die further has at least one air vent configured to receive air, most preferably from a high-pressure air source and further has at least one air vent pin chamber. Each air vent pin chamber has an air vent pin slidably disposed therein and that is functional to prevent ambient air from entering the mold injection chamber when high pressure air is not transmitted into the at least one air vent. Upon injecting high pressure air into the at least one air vent, each air vent pin is forced to controllably vent the high pressure air and simultaneously slide in its respective chamber away from the mold injection chamber to expose the mold injection chamber to the high pressure air. The high pressure air entering the mold injection chamber causes the upper die to separate from the mold resin provided by the resin injection process such that no mechanical stresses are created between the IC chip and the mold resin such as those mechanical stresses caused by ejector pins associated with many known transfer mold processes. Further, a release film is not required when separating the upper die from the mold resin; and so there is no need to deal with release film residue.

According to one aspect of the invention, an air release molding system is provided that does not employ ejector pins to separate the die from the mold resin.

In another aspect of the invention, an air release molding system is provided that does not employ a release film to separate the die from the mold resin.

In yet another aspect of the invention, an air release molding system is provided to minimize mechanical stresses placed onto an IC chip during the die release process.

In still another aspect of the invention, an air release molding system is provided to minimize delamination between the molded resin and an IC chip substrate during the die release process.

### BRIEF DESCRIPTION OF THE DRAWINGS

Other aspects, features and attendant advantages of the present invention will be readily appreciated as the present invention becomes better understood by reference to the following detailed description when considered in connection with the accompanying drawings in which like reference numerals designate like parts throughout the figures thereof and wherein:

FIG. 1(a) illustrates an injection mold during the die set process in which the upper die employs ejector pins and that is well known in the art;

FIG. 1(b) illustrates the injection mold depicted in FIG. 1(a) following injection of mold resin during the resin injection process;

FIG. 1(c) illustrates the injection mold depicted in FIGS. 1(a) and 1(b), wherein the ejector pins are employed to separate the upper die from the mold resin during the die release process;

FIG. 2(a) illustrates an injection mold during the die set process wherein a die release film is placed between the upper die and the mold resin chamber;

FIG. 2(b) illustrates the injection mold depicted in FIG. 2(a) following injection of mold resin during the resin injection process;

FIG. 2(c) illustrates the injection mold depicted in FIGS. 2(a) and 2(b) wherein the die release film is employed to separate the upper die from the mold resin during the die release process;

FIG. 3(a) illustrates an injection mold during the die set process wherein the upper die employs air vent pins according to one embodiment of the present invention;

FIG. 3(b) illustrates the injection mold depicted in FIG. 3(a) following injection of mold resin during the resin injection process; and

FIG. 3(c) illustrates the injection mold depicted in FIGS. 3(a) and 3(b) wherein the air vent pins are employed to separate the upper die from the mold resin during the die release process.

While the above-identified drawing figures set forth alternative embodiments, other embodiments of the present invention are also contemplated, as noted in the discussion. In all cases, this disclosure presents illustrated embodiments of the present invention by way of representation and not limitation. Numerous other modifications and embodiments can be devised by those skilled in the art which fall within the scope and spirit of the principles of this invention.

### DETAILED DESCRIPTION OF THE PREFERRED EMBODIMENTS

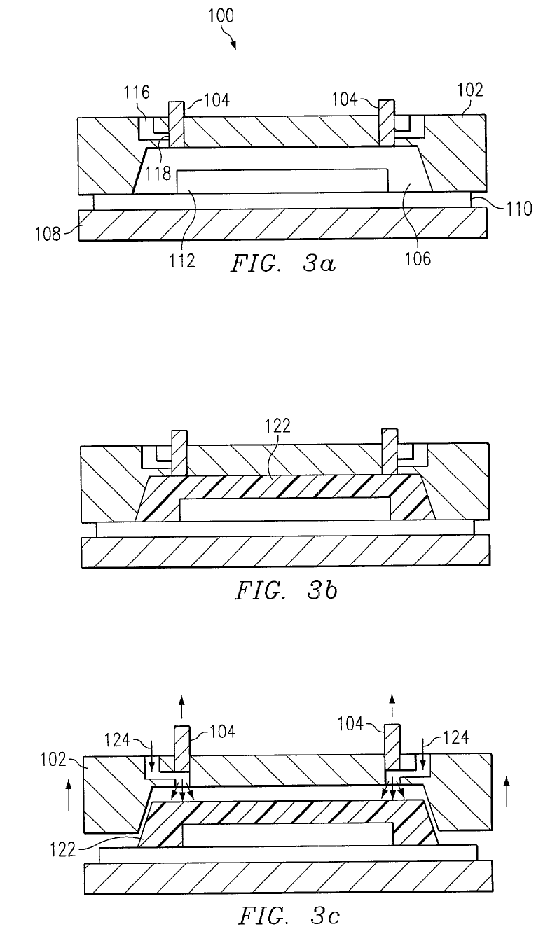

FIG. 3(a) illustrates an injection mold system 100 during the die set process wherein the upper die 102 employs air vent pins 104 according to one embodiment of the present invention. The air release injection molding system 100 injects air from a high pressure air supply into the die (mold injection) chamber 106 during the mold die release process to eradicate mold resin sticking onto the upper mold die 102 during the die release process. The air release injection molding system 100 is an injection mold comprising a lower die 108 configured for placement of a substrate 110 having an IC chip 112 attached there upon. The air release injection molding system 100 further comprises an upper die 102 having a mold injection chamber 106 disposed therein, as stated herein before. The upper die 102 further has at least one air vent 116 configured to receive air, most preferably from a high-pressure air source, and further has at least one air vent pin chamber 118. Each air vent pin chamber 118 has an air vent pin 104 slidably disposed therein and that is functional to prevent ambient air from entering the mold injection chamber 106 when high pressure air is not transmitted into the at least one air vent 116. Upon injecting high pressure air into the at least one air vent 116, each air vent pin 104 is forced to controllably vent the high pressure air and simultaneously slide in its respective chamber 118 away from the mold injection chamber 106 to open each air vent 116 to expose the mold injection chamber 106 to the high pressure air.

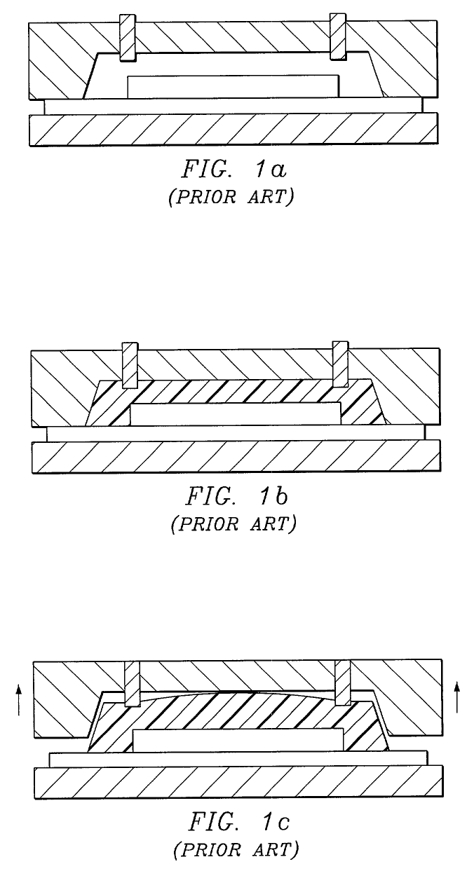

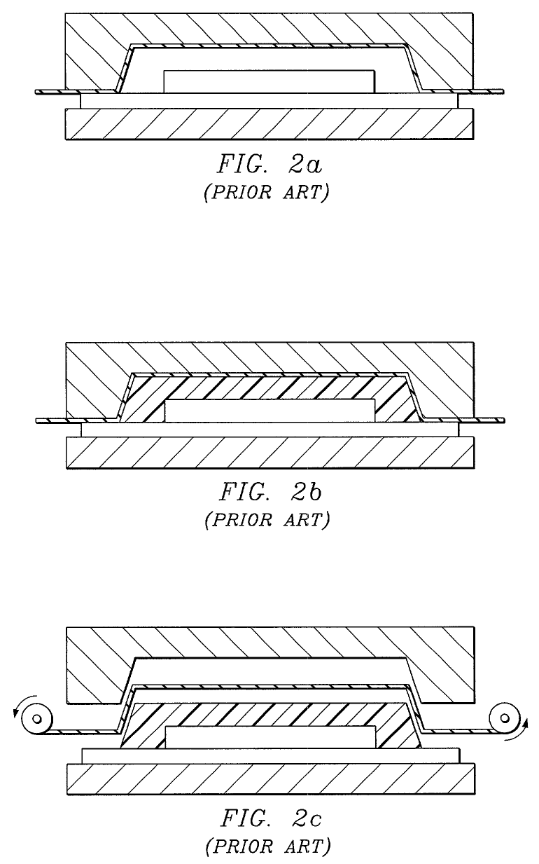

FIG. 3(b) illustrates the injection mold system 100 depicted in FIG. 3(a) following injection of mold resin 122 during the resin injection process; while FIG. 3(c) illustrates the injection mold system 100 depicted in FIGS. 3(a) and 3(b) in which the air vent pins 104 are deployed to separate the upper die 102 from the mold resin 122 during the die release process. The high pressure air 124 entering the mold injection chamber 106 causes the upper die 102 to separate from the mold resin 122 injected during the resin injection process such that no mechanical stresses are created between the IC chip 112 and the mold resin 122, such as those mechanical stresses caused by the ejector pins illustrated in FIGS. 1(a)-1(c), and associated with many known transfer mold processes. Further, a release film such as that illustrated in FIGS. 2(a)-2(c) is not required when separating the upper die 102 from the mold resin 122; and so there is no need to deal with release film residue.

In view of the above, it can be seen the present invention presents a significant advancement in the art of separating transfer molded IC chips from the die during the die release process. This invention has been described in considerable detail in order to provide those skilled in the signal filtering art with the information need to apply the novel principles and to construct and use such specialized components as are required. In view of the foregoing descriptions, it should be apparent that the present invention represents a significant departure from the prior art in construction and operation. However, while particular embodiments of the present invention have been described herein in detail, it is to be understood that various alterations, modifications and substitutions can be made therein without departing in any way from the spirit and scope of the present invention, as defined in the claims that follow.

What is claimed is:

1. A molding system comprising:
a lower die having an upper portion configured for placement of transfer molded integrated circuits (ICs) there upon;
an upper die having at least one air vent disposed there through and further having at least one air vent pin chamber disposed there through, the upper die and the lower die together forming a mold die; and
an air vent pin slidably disposed within each air vent pin chamber, wherein each air vent pin is operational in response to high-pressure air injected into the at least one air vent such that each air vent pin is forced by the high-pressure air to slide in its respective air vent pin chamber to expose the mold die to the high-pressure air and is further operational in the absence of such high-pressure air such that each air vent pin slides in its respective air vent pin chamber to block passage of ambient air into the mold die.

2. The molding system according to claim 1 wherein each air vent pin is configured to controllably vent high-pressure air injected into the at least one air vent during a die release process such that a desired air pressure is attained between a mold resin injected into the mold die during a resin injection process and the upper die to cause separation of the upper die from the mold resin during the die release process, wherein mechanical stresses placed upon a transfer molded IC chip contained between the upper die and lower die are reduced to a lower level than that achievable using a molding system that employs ejector pins.

3. A molding system comprising:
a lower die; and
an upper die configured to inject high-pressure air into a mold die formed by the lower die and the upper die to eradicate mold resin sticking onto the mold die during a die release process.

4. The molding system according to claim 3 wherein the lower die is configured for placement of transfer molded ICs there upon.

5. The molding system according to claim 3 wherein the upper die has at least one air vent disposed there through and further has at least one air vent pin chamber disposed there through and further has an air vent pin slidably disposed within each air vent pin chamber, wherein each air vent pin is operational in response to high-pressure air injected into the at least one air vent such that each air vent pin is forced by the high-pressure air to slide in its respective air vent pin chamber to expose the mold die formed by the upper and lower dies to the high-pressure air and further wherein each air vent pin is operational in the absence of such high-pressure air such that each air vent pin slides in its respective air vent pin chamber to block passage of ambient air into the mold die formed by the upper and lower dies.

6. The molding system according to claim 5 wherein each air vent pin is configured to controllably vent high-pressure air injected into the at least one air vent during the die release process such that a desired air pressure is attained between a mold resin injected into the mold die formed by the upper and lower dies during a resin injection process and the upper die to cause separation of the upper die from the mold resin during the die release process, wherein mechanical stresses placed upon a transfer molded IC chip contained between the upper die and lower die are reduced to a lower level than that achievable using a molding system that employs ejector pins.

7. A method of providing a transfer molded integrated circuit (IC), the method comprising the steps of:
providing a molding system configured to inject high-pressure air into a mold die formed by a lower die and an upper die, to prevent mold resin sticking onto the mold die during a die release process;
placing a semiconductor package comprising a substrate and an IC chip upon the lower die;
setting the upper die such that the upper die and low die together form a mold die;
injecting a mold resin into the mold die to provide a transfer molded IC; and
injecting air into the mold die to cause the upper die to separate from the mold resin.

8. The method according to claim 7 wherein the step of injecting air into the mold die further comprises injecting high-pressure air into the mold die such that mechanical stresses placed upon the transfer molded IC contained between the upper die and lower die are reduced to a lower level than that achievable using a molding system that employs ejector pins.
